(19) United States
(12) Patent Application Publication
(10) Pub. No.: US 2022/0136225 A1
(43) Pub. Date: May 5, 2022

(54) SLIDE RAIL ASSEMBLY AND SHOWER ASSEMBLY

(71) Applicant: JOMOO KITCHEN & BATH CO., LTD, Nan'an City (CN)

(72) Inventors: Xiaofa LIN, Nan'an City (CN); Xiaoshan LIN, Nan'an City (CN); Chuanyi ZHANG, Nan'an City (CN); Yaoting QI, Nan'an City (CN); Lichuan WU, Nan'an City (CN)

(73) Assignee: JOMOO KITCHEN & BATH CO., LTD, Nan'an City (CN)

(21) Appl. No.: 17/171,407

(22) Filed: Feb. 9, 2021

(30) Foreign Application Priority Data
Nov. 2, 2020 (CN) 202022494350.1

(51) Int. Cl. E03C 1/06; F16M 13/02

(52) U.S. Cl. CPC E03C 1/066; F16M 2200/027; F16M 13/02

(57) ABSTRACT

A slide rail assembly includes a slide rail, a sliding assembly slidably installed on the slide rail, and a locking mechanism capable of locking and releasing the sliding assembly. The locking mechanism includes a control button, a transmission member, a friction block and an elastic restoring member. The control button is installed on the sliding assembly and includes a movable member which can reciprocate. The movable member is in transmission connection with a first end of the transmission member. A second end of the transmission member is connected with the friction block. The elastic restoring member is provided between the sliding assembly and the transmission member, and the friction block is movably installed on the sliding assembly and can move towards or away from the slide rail.

### CROSS-REFERENCE TO RELATED APPLICATIONS

This application claims priority to Chinese patent application No. 202022494350.1 filed on Nov. 2, 2020, the entirety of which is hereby incorporated by reference herein.

### TECHNICAL FIELD

This disclosure relates to, but is not limited to, the field of bathroom products, in particular to, but not limited to, a slide rail assembly and a shower assembly.

### BACKGROUND

Showers in the bathrooms may be fixed, hand-held and hybrid. The hand-held shower needs to be held in hand for shower, which is inconvenient to use. The fixed shower is fixed on the wall through a bracket, which leads to limited use range and inconvenience. The hybrid shower can be either fixed on a bracket on the wall or taken down for use, but it is also inconvenient to use.

### SUMMARY

The following is a summary of the subject matter described in detail in this disclosure. This summary is not intended to limit the scope of protection of the claims.

A slide rail assembly includes a slide rail, a sliding assembly slidably installed on the slide rail, and a locking mechanism capable of locking and releasing the sliding assembly. The locking mechanism includes a control button, a transmission member, a friction block and an elastic restoring member. The control button is installed on the sliding assembly and includes a movable member which can reciprocate, the movable member is in transmission connection with a first end of the transmission member. One of the movable member and the transmission member is provided with a transmission surface inclined relative to a sliding direction of the sliding assembly, and the other of the movable member and the transmission member is provided with a transmission matching surface abutting against the transmission surface. A second end of the transmission member is connected with the friction block. The elastic restoring member is provided between the sliding assembly and the transmission member. The friction block is movably installed on the sliding assembly and can move towards or away from the slide rail. The friction block can move to contact with the slide rail under the action of the elastic restoring member, so that the sliding assembly is locked relative to the slide rail under the action of a friction force of the friction block. The friction block can move out of contact with the slide rail under the driving of the movable member and the transmission member, so that the sliding assembly can slide relative to the slide rail.

A shower assembly includes a shower and the above-mentioned slide rail assembly, the shower is installed on the sliding assembly of the slide rail assembly.

Other features and advantages of embodiments of the present disclosure will be set forth in the following description.

### BRIEF DESCRIPTION OF THE DRAWINGS

FIG. 1 is a schematic structural diagram of a slide rail assembly according to an embodiment of the present disclosure;

FIG. 2 is a first schematic structural diagram of a shower assembly according to an embodiment of the present disclosure;

FIG. 3 is a second schematic structural diagram of a shower assembly according to an embodiment of the present disclosure;

FIG. 4 is a schematic exploded structural diagram of the slide rail assembly shown in FIG. 1;

FIG. 5 is a schematic structural diagram of a control button of the slide rail assembly shown in FIG. 4;

FIG. 6 is a schematic structural diagram of a transmission member of the slide rail assembly shown in FIG. 4;

FIG. 7 is a schematic structural diagram of a bushing of the slide rail assembly shown in FIG. 4;

FIG. 8 is a schematic structural diagram of an installation seat of the slide rail assembly shown in FIG. 4;

FIG. 9 is a schematic structural diagram of a slide seat of the slide rail assembly shown in FIG. 4;

FIG. 10 is a schematic structural diagram of an end cover of the slide rail assembly shown in FIG. 4;

FIG. 11 is a first schematic sectional structural diagram of a locking mechanism of the slide rail assembly shown in FIG. 1 when it is in a locking state;

FIG. 12 is a second schematic sectional structural diagram of a locking mechanism of the slide rail assembly shown in FIG. 1 when it is in a locking state;

FIG. 13 is a first schematic sectional structural diagram of a locking mechanism of the slide rail assembly shown in FIG. 1 when it is in a releasing state;

FIG. 14 is a second schematic sectional structural diagram of a locking mechanism of the slide rail assembly shown in FIG. 1 when it is in a releasing state;

FIG. 15 is a schematic enlarged diagram of the structure of part A in FIG. 14;

FIG. 16 is a first schematic sectional structural diagram of the slide rail assembly shown in FIG. 1;

FIG. 17 is a second schematic sectional structural diagram of the slide rail assembly shown in FIG. 1; and

FIG. 18 is a schematic partial diagram of the sectional structure of the slide rail assembly shown in FIG. 1.

### REFERENCE SIGNS

1—slide rail,
11—chute,
21—slide seat,
211—installation through hole,
212—pulley groove,
22—installation bracket,
221—second side surface,
222—second plane,
223—horizontal limiting rib,
23—end cover,
231—lever support portion,
232—installation portion,
233—horizontal connecting portion,
234—vertical limiting portion,
235—avoidance slope,
236—swing support surface,
237—first side surface,
238—first plane,
24—screw,
25—pulley,
26—pin,
31—control push button,
311—movable member,
312—transmission surface,
32—transmission member,
321—latching portion,
322—plug,
33—bushing,
331—transmission matching surface,
332—latching slot,
34—installation seat,
341—installation groove,
342—installation post,
343—slot,
35—friction block,
36—elastic restoring member,
4—shower holder,
5—shower.

### DETAILED DESCRIPTION

Embodiments of the present disclosure will be described in detail below with reference to the accompanying drawings. It should be noted that the embodiments in the present disclosure and the features in the embodiments can be arbitrarily combined with each other if there is no conflict.

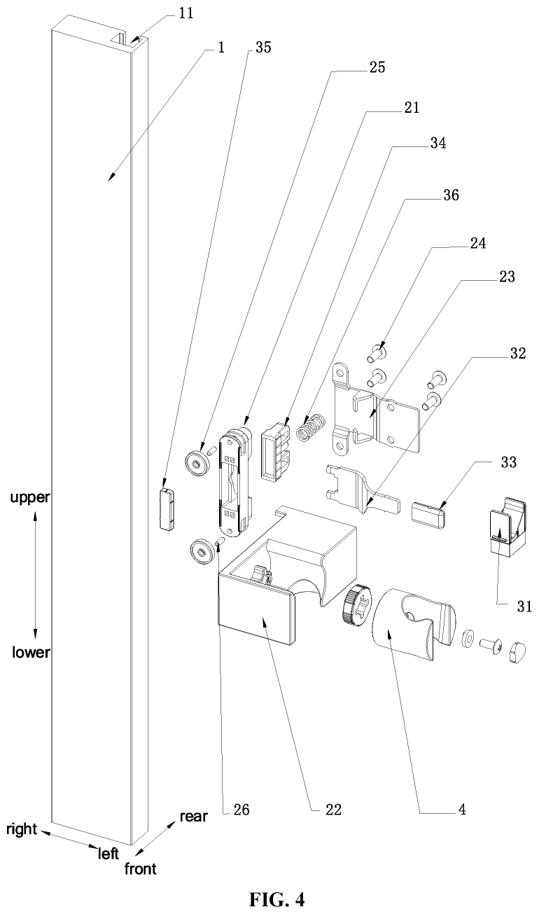

In the description of the present disclosure, it should be understood that the orientation or positional relationship indicated by the terms such as “upper”, “lower”, “front”, “rear”, “left” and “right” are based on the orientation or positional relationship shown in FIG. 4, which is only for the convenience of describing the present disclosure and simplifying the description, but does not indicate or imply that the referred devices or elements must have a specific orientation, be constructed and operated in a specific orientation. Therefore, it cannot be understood as a limitation of the present disclosure.

In addition, the terms “first” and “second” are only used for descriptive purposes, and cannot be understood as indicating or implying relative importance or implicitly indicating the number of the indicated technical features. Therefore, the features defined with “first” and “second” may explicitly or implicitly include one or more of the features.

In the present disclosure, unless otherwise specified and limited, the terms such as “install”, “connect” and “fix” should be understood in a broad sense. For example, it may be a fixed connection, a detachable connection, or a whole; it may be a mechanical connection, an electrical connection, or a communication; it may be a direct connection or an indirect connection through an intermediate medium, and it may be interconnection between two elements or the interaction between two elements. For a person of ordinary skill in the art, the specific meanings of the above terms in the present disclosure can be understood according to specific situations.

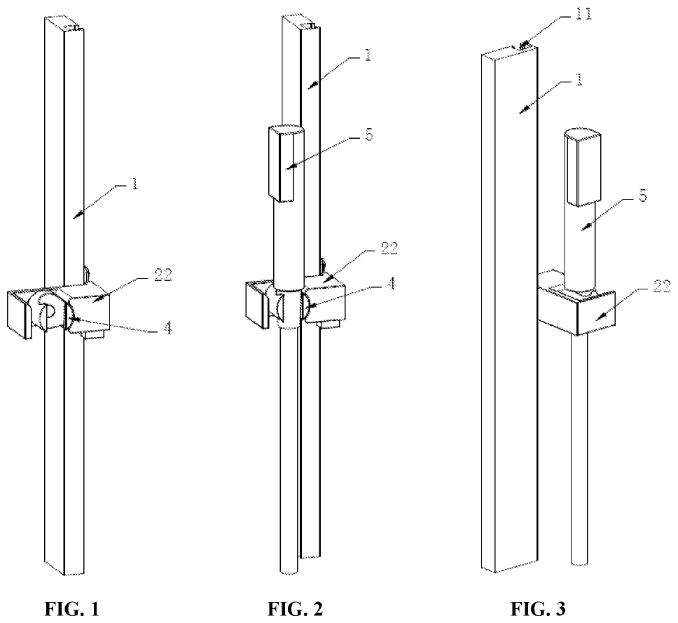

As shown in FIGS. 1-3, an embodiment of the present disclosure provides a slide rail assembly, which may be connected with a shower 5 (such as a hand-held shower 5, etc.) to adjust the position of the shower 5. Alternatively, the slide rail assembly may be connected with other devices to adjust the position of other devices.

As shown in FIG. 4, the slide rail assembly includes a slide rail 1, a sliding assembly and a locking mechanism.

As shown in FIG. 4, the slide rail 1 can be vertically provided, and the sliding assembly can be slidably installed on the slide rail 1, so that the sliding assembly can move up and down along the slide rail 1. It should be understood that the slide rail 1 can not only be vertically arranged in an up-down direction, but also be horizontally arranged in a left-right direction or a front-rear direction, that is, the whole slide rail assembly can be transversely placed, and then the sliding assembly can move horizontally along the slide rail 1.

The shower 5 or other devices may be installed on the sliding assembly, so that the sliding assembly can drive the shower 5 or other devices to move so as to adjust the position of the shower 5 or other devices.

The locking mechanism can lock and release the sliding assembly. As shown in FIG. 4, the locking mechanism includes a control button, a transmission member 32, a friction block 35 and an elastic restoring member 36.

As shown in FIGS. 4-5 and FIGS. 11-14, the control button is installed on the sliding assembly and includes a movable member 311 that can reciprocate. The movable member 311 is in transmission connection with a first end of the transmission member 32 (i.e., motion can be transmitted between the movable member 311 and the transmission member 32, and they can be connected or contacted with each other). One of the movable member 311 and the transmission member 32 is provided with a transmission surface 312 inclined relative to a sliding direction (such as a vertical direction) of the sliding assembly, while the other of the movable member 311 and the transmission member 32 is provided with a transmission matching surface 331 abutting against the transmission surface 312. A second end of the transmission member 32 is connected with the friction block 35. The elastic restoring member 36 is provided between the sliding assembly and the transmission member 32. The friction block 35 is movably installed on the sliding assembly and can move toward or away from the slide rail 1.

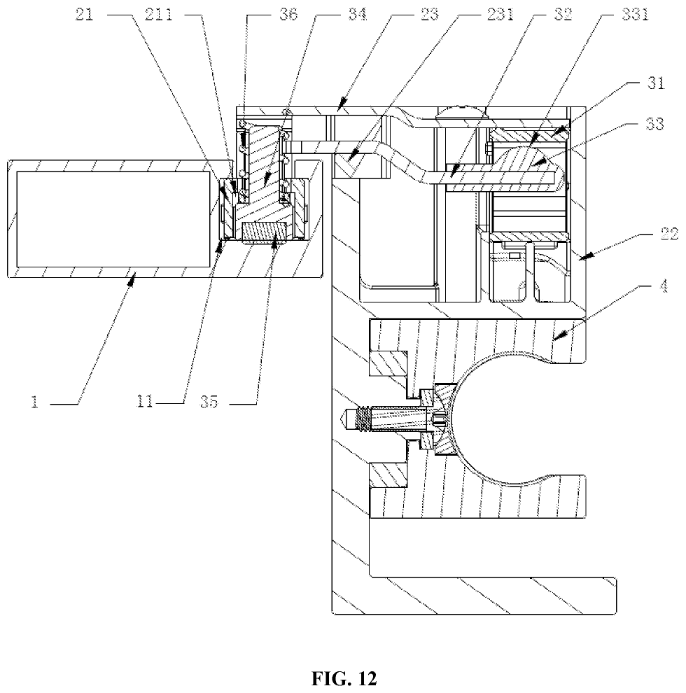

As shown in FIG. 11 and FIG. 12, the friction block 35 can move to contact with the slide rail 1 under the action of the elastic restoring member 36, so that the sliding assembly is locked relative to the slide rail 1 under the action of a friction force of the friction block 35. Specifically, the elastic restoring member 36 can exert an elastic force on the transmission member 32 to cause the transmission member 32 to move, and the transmission member 32 can drive the friction block 35 to move, so that the friction block 35 contacts with the slide rail 1. At this time, the locking mechanism is in a locking state shown in FIG. 11 and FIG. 12. Under the action of friction force between the friction block 35 and the slide rail 1, the sliding assembly is locked on the slide rail 1 and cannot slide along the slide rail 1.

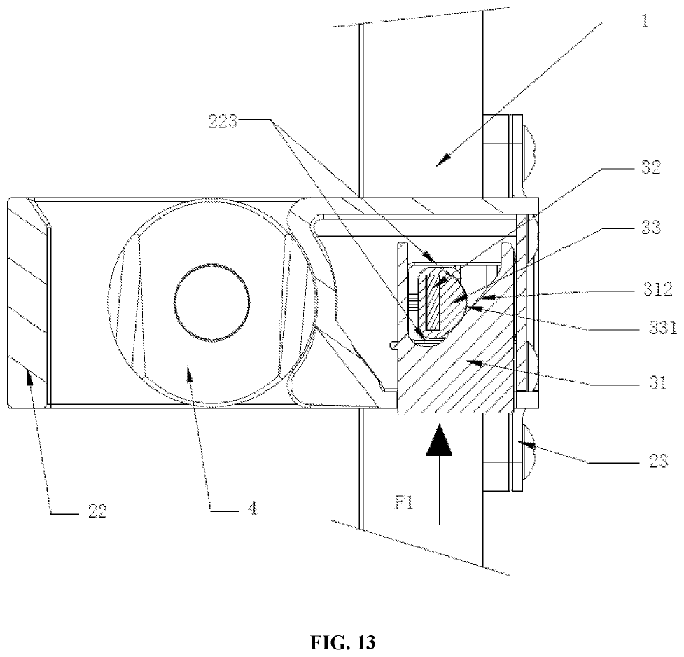

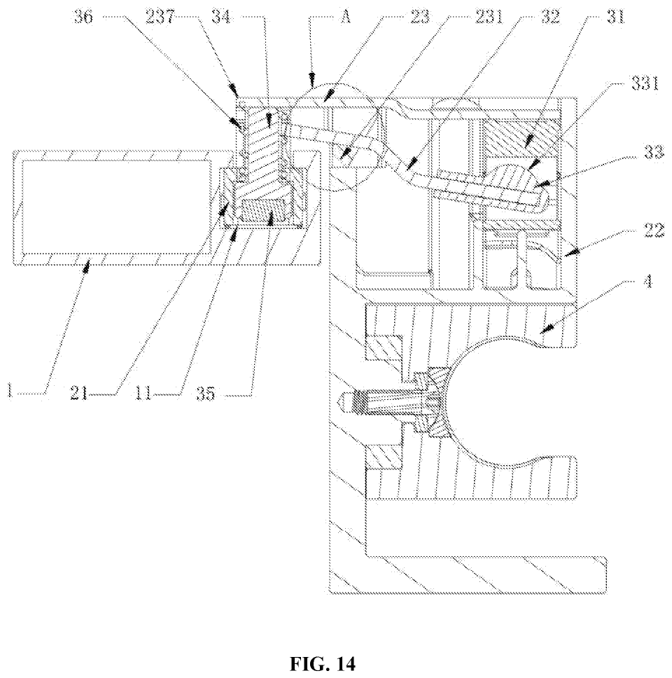

As shown in FIG. 13 and FIG. 14, the friction block 35 can also be driven by the movable member 311 and the transmission member 32 to move out of contact with the slide rail 1, so that the sliding assembly can slide relative to the slide rail 1. Specifically, when the control button is operated, the movable member 311 of the control button moves. Through the transmission cooperation between the transmission surface 312 and the transmission matching surface 331, the movable member 311 drives the transmission member 32 to move, and further the transmission member 32 drives the friction block 35 connected therewith to move, so that the friction block 35 moves away from the slide rail 1 to get out of contact with the slide rail 1. At this time, the locking mechanism is in a releasing state shown in FIG. 13 and FIG. 14, and the sliding assembly can slide along the slide rail 1.

The locking mechanism has a releasing state and a locking state, and can be used for locking or releasing the sliding assembly. The locking mechanism can be in the releasing state shown in FIG. 13 and FIG. 14 by operating the control button, and the elastic restoring member 36 can restore the locking mechanism to the locking state shown in FIG. 11 and FIG. 12.

When the control button is operated, the movable member 311 of the control button moves, and the force is transmitted through the cooperation between the transmission surface 312 and the transmission matching surface 331, so that the transmission member 32 moves. The transmission member 32 drives the friction block 35 connected therewith to move away from the slide rail 1 to get out of contact with the slide rail 1. At this time, the locking mechanism is in a releasing state (as shown in FIG. 13 and FIG. 14). The sliding assembly can slide along the slide rail 1 to adjust the position of the sliding assembly and the shower 5 or the like thereon. After the shower 5 moves to a proper position, the control button is released, and under the action of the elastic restoring member 36, the control button and the friction block 35 are driven by the transmission member 32 to reset, so that the friction block 35 returns to contact with the slide rail 1. At this time, the locking mechanism is in a locking state (as shown in FIG. 11 and FIG. 12). Under the friction force between the friction block 35 and the slide rail 1, the sliding assembly is locked on the slide rail 1 and cannot slide, so as to fix the shower 5 or the like.

With the slide rail assembly of the embodiments of the present disclosure, it is convenient to adjust and fix the position of the shower 5 or the like, and it is convenient for users to use.

In some exemplary embodiments, as shown in FIGS. 1-4, the slide rail 1 is provided with a chute 11, and at least a part of the sliding assembly is installed in the chute 11 and can move along the chute 11. The chute 11 can be provided at a rear side of the slide rail 1 (that is, the side of the slide rail 1 facing an installing base such as a wall surface), so that the chute 11 is invisible, thereby improving the overall appearance effect. The chute 11 is not provided on a left side, a right side and a front side of the slide rail 1, which is convenient for cleaning and wiping an exposed surface (appearance surface) of the slide rail 1.

In some exemplary embodiments, the control button is a pressable control push button 31, the transmission surface 312 is provided on the movable member 311 of the control push button 31, and along a pressing direction of the control push button 31, the transmission surface 312 is a flat surface or an arc surface inclined in a direction away from the transmission matching surface 331. Alternatively, the transmission surface may be provided on the transmission member 32, and along the pressing direction of the control push button 31, the transmission surface is a flat surface or an arc surface inclined toward a direction close to the transmission matching surface.

In some exemplary embodiments, the control button is a control push button 31 that can be pressed in the vertical direction (i.e., the sliding direction of the sliding assembly), the transmission surface 312 is provided on the movable member 311 of the control push button 31, and along the pressing direction (from top to bottom or from bottom to top) of the control push button 31, the transmission surface 312 is a flat surface or an arc surface inclined in a direction away from the transmission matching surface 331.

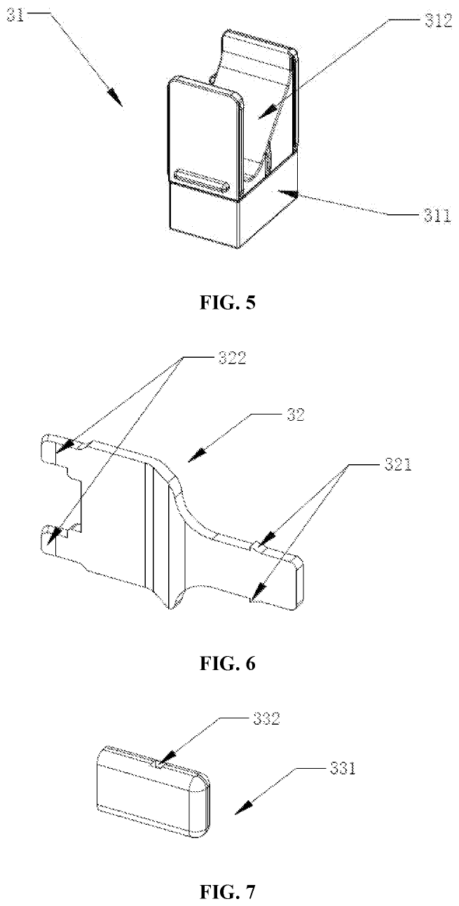

As shown in FIG. 4, FIG. 5, FIG. 11 and FIG. 13, the control button is a control push button 31 provided on a lower side of the sliding assembly, and the control push button 31 can be pressed upward. The transmission surface 312 on the control push button 31 is a flat surface, which inclines away from the transmission matching surface 331 along the pressing direction (i.e., from bottom to top) of the control push button 31.

When the control push button 31 is pressed, the movable member 311 moves upwards, and a lower end of the transmission surface 312 on the movable member 311 gradually moves to contact with the transmission matching surface 331 at a first end of the transmission member 32. Through the interaction between the transmission surface 312 and the transmission matching surface 331, the transmission member 32 moves to drive the friction block 35 to move so as to get out of contact with the slide rail 1, so that the locking mechanism is in a releasing state. When the control push button 31 is released, under the action of the elastic restoring member 36, the transmission member 32 moves in reverse to drive the friction block 35 and the control push button 31 to move in reverse, so that the control push button 31 is reset, and the friction block 35 returns to contact with the slide rail 1, making the locking mechanism in the locking state.

It should be understood that the control button can be a control push button 31 provided on the upper side, left side, right side or front side or the like of the sliding assembly.

In some exemplary embodiments, the control button is a control knob, and when the movable member 311 rotates, the transmission surface can be cooperated with the transmission matching surface to drive the transmission member to move. The control knob can be provided on the upper side, lower side, left side, right side or front side or the like of the sliding assembly.

In some exemplary embodiments, as shown in FIG. 11 and FIG. 13, the transmission matching surface 331 is an arc-shaped surface protruding toward the transmission surface 312.

The transmission matching surface 331 is an arc-shaped surface protruding toward the transmission surface 312, which, on one hand, ensures that the transmission matching surface 331 is in contact with the transmission surface 312 so as to realize the transmission cooperation between the control push button 31 and the transmission member 32, and on the other hand, may reduce a contact area between the transmission matching surface 331 and the transmission surface 312, and reduce a sliding friction force between the transmission surface 312 and the transmission matching surface 331, thereby reducing the pressing force on the control push button 31.

In some exemplary embodiments, as shown in FIG. 5, FIG. 11 and FIG. 13, the movable member 311 is provided with a groove, a first end of the transmission member 32 extends into the groove, and one of inner wall surfaces of the groove forms the transmission surface 312.

In some exemplary embodiments, as shown in FIG. 4 and FIGS. 11-14, the locking mechanism further includes a bushing 33 sleeved outside the first end of the transmission member 32, and the transmission matching surface 331 is provided on an outer surface of the bushing 33.

As shown in FIG. 4 and FIG. 5, the movable member 311 of the control push button 31 is provided with a groove which penetrates left and right and is open at the upper side. A rear inner wall surface of the groove forms the transmission surface 312, which gradually inclines backward from bottom to top.

As shown in FIG. 4, FIG. 12 and FIG. 14, the transmission member 32 extends in the left-right direction, and a left end (i.e., the first end) of the transmission member 32 extends into the groove. The bushing 33 is sleeved outside the left end of the transmission member 32, and a rear side surface of the bushing 33 protrudes backward to form an arc-shaped transmission matching surface 331.

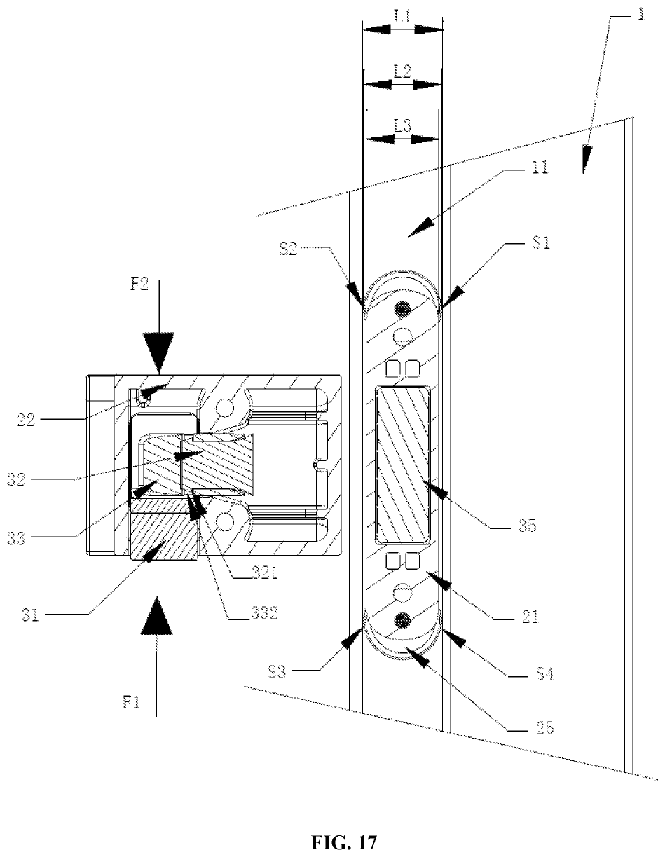

The bushing 33 and the transmission member 32 can be fixed to each other by a snap connection. As shown in FIG. 6 and FIG. 7, the bushing 33 is provided with a latching slot 332, the transmission member 32 is provided with a latching portion 321. The latching portion 321 is snap-connected with the latching slot 332 (see FIG. 17), so that the bushing 33 and the transmission member 32 are firmly fixed to each other. The fixing mode of the bushing 33 and the transmission member 32 is not limited to fixing by a snap connection, for example, fixing can be realized by interference fit.

When the control push button 31 is pressed, the movable member 311 moves upward, and the transmission surface 312 on the movable member 311 presses the transmission matching surface 331, so that the left end of the transmission member 32 moves towards the front side, while a right end (i.e., the second end, opposite to the first end) of the transmission member 32 drives the friction block 35 to move towards the rear side (in a direction away from the slide rail 1), so that a front end surface of the friction block 35 is out of contact with the chute 11 of the slide rail 1, thereby facilitating the sliding assembly to slide along the slide rail 1. When the control push button 31 is released, under the action of the elastic restoring member 36, the transmission member 32 moves in reverse, drives the friction block 35 and the control push button 31 to move in reverse, so that the control push button 31 is restored downwards, and the friction block 35 returns to make the front end surface thereof contact with the chute 11 of the slide rail 1, and the sliding assembly is locked and fixed on the slide rail 1 under the friction force of the friction block 35.

The bushing 33 is sleeved outside the transmission member 32, and the transmission matching surface 331 of the bushing 33 contacts with the transmission surface 312 of the control push button 31 and the friction occurs therebetween. Therefore, the bushing 33 can be made of a wear-resistant material. The arrangement of the bushing 33 avoids the wear of the transmission member 32.

In some exemplary embodiments, the first end of the transmission member 32 is not sleeved with the bushing 33, and the transmission matching surface is provided on the outer surface of the transmission member 32. The rear side surface of the left end of the transmission member 32 may protrude backward to form an arc-shaped transmission matching surface.

In some exemplary embodiments, the transmission surface is provided on the outer surface of the transmission member 32 or the outer surface of the bushing 33, and the transmission matching surface is provided on the movable member 311.

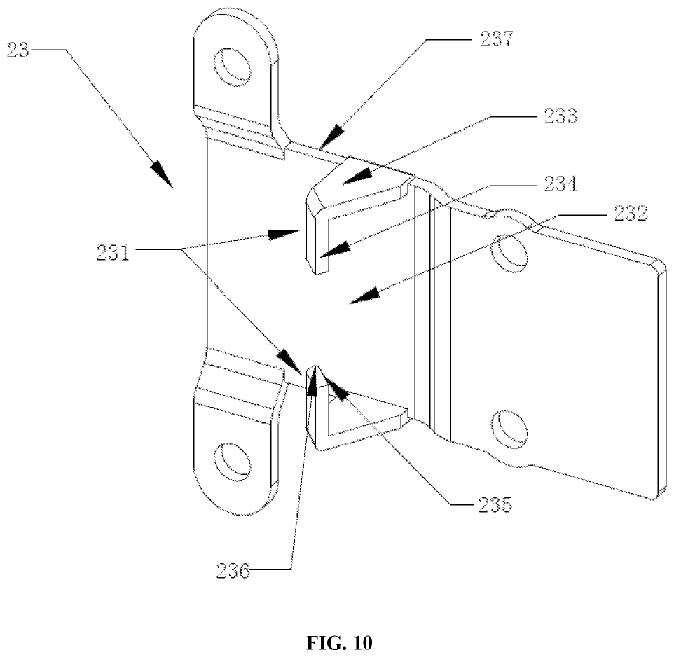

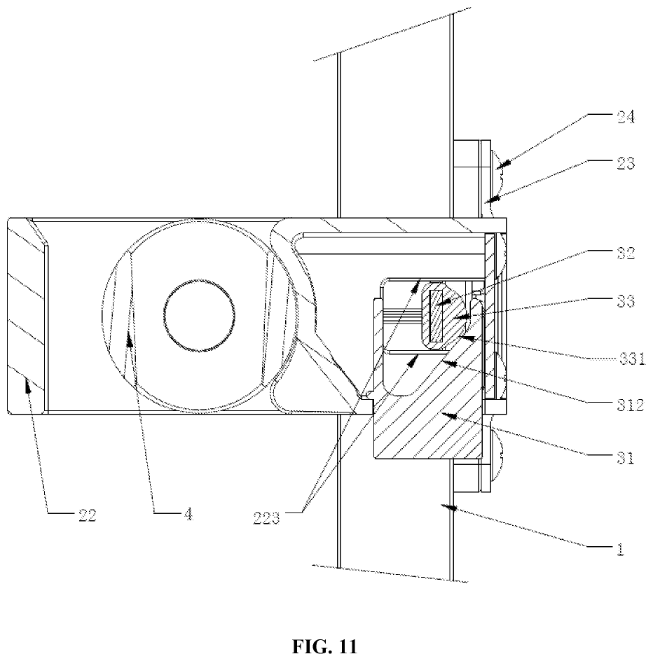

In some exemplary embodiments, as shown in FIG. 4, FIG. 10, FIG. 12 and FIG. 14, the transmission member 32 is a lever-type transmission member, the sliding assembly includes an installation portion 232 and a lever support portion 231 fixed on the installation portion 232, and the lever-type transmission member 32 is supported on the lever support portion 231.

The transmission member 32 is a lever-type transmission member, which is supported on the lever support portion 231 provided on the installation portion 232 of the sliding assembly, so that the lever-type transmission member 32 can swing around the lever support portion 231, and the opposite first and second ends of the lever-type transmission member 32 swing in opposite directions.

In order to ensure that the locking mechanism can firmly lock the sliding assembly, so that the sliding assembly is stable and will not fall even under long-term stress, the elastic restoring member 36 is needed to provide a greater elastic force value to the friction block 35, so that the friction block 35 can be stably and firmly pressed into the chute 11 of the slide rail 1 so as to realize the locking. When the sliding assembly is released from the locking and slides, the control push button 31 is pressed, it is needed to generate a greater force to overcome the elastic force of the elastic restoring member 36, so that the friction block 35 moves out of contact with the chute 11. However, at the same time, a relatively small force is needed when the user presses the control push button 31, because the user experience effect will be better if the pressing force is smaller.

In order to overcome the above contradiction, as shown in FIG. 12 and FIG. 14, a portion of the lever-type transmission member 32 adjacent to the second end is supported on the lever support portion 231, so that the moment arm of the first end of the lever-type transmission member 32 is longer and the moment arm of the second end is shorter, thereby forming a simple labor-saving mechanism. Due to the principle of saving labor by lever, a smaller force pressing the control push button 31 can overcome the larger elastic force of the elastic restoring member 36.

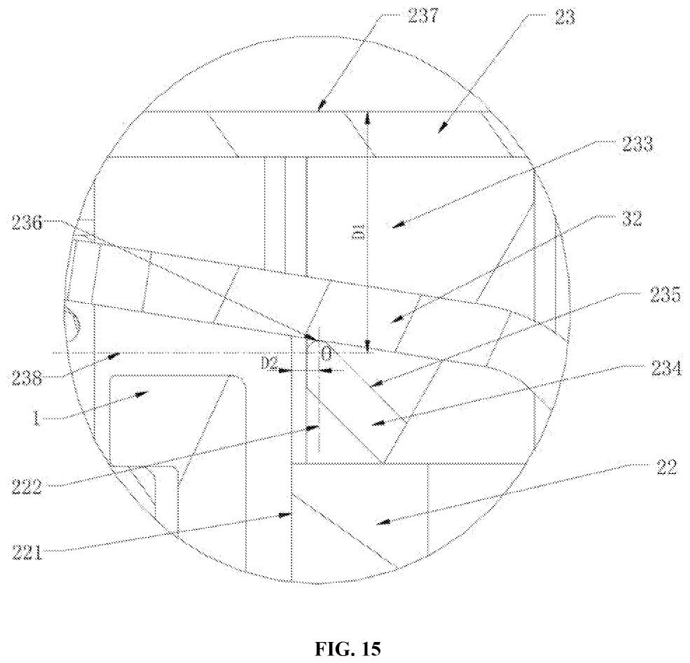

In some exemplary embodiments, as shown in FIG. 10 and FIG. 15, the lever support portion 231 includes a swing support surface 236, which is a cylindrical surface extending along the sliding direction (such as the vertical direction) of the sliding assembly, and is in line contact with the lever-type transmission member 32.

The swing support surface 236 of the lever support portion 231 is a cylindrical surface extending in the vertical direction, a generatrix of the cylindrical surface is a vertical line extending in the up-down direction, and the generatrix moves in parallel along a curve to form the cylindrical surface. The lever-type transmission member 32 swings around the swing support surface 236 in a horizontal plane and is in line contact with different portions of the swing support surface 236.

To prevent the lever-type transmission member 32 from shaking in the sliding direction (such as vertical direction) of the sliding assembly, the lever-type transmission member 32 can be limited. In some exemplary embodiments, as shown in FIG. 11 and FIG. 13, the sliding assembly is provided with horizontal limiting ribs 223 for limiting the lever-type transmission member 32, and the horizontal limiting ribs 223 can limit the lever-type transmission member 32 in the up-down direction.

In some exemplary embodiments, as shown in FIG. 11 and FIG. 13, an upper horizontal limiting rib 223 and a lower horizontal limiting rib 223 are provided in the sliding assembly, and the two horizontal limiting ribs 223 are located on the upper and lower sides of the bushing 33, respectively. Through the cooperation between the horizontal limiting ribs 223 and the bushing 33, the lever-type transmission member 32 can be limited in the vertical direction. When the lever-type transmission member 32 swings, sliding friction occurs between the upper and lower sides of the bushing 33 and the horizontal limiting ribs 223, thus avoiding the wear of the lever-type transmission member 32. With the bushing 33, the friction and wear between the lever-type transmission member 32 and the transmission surface 312, and the friction and wear between the lever-type transmission member 32 and the horizontal limiting ribs 223 are avoided.

In some exemplary embodiments, as shown in FIG. 10, the lever support portion 231 is L-shaped, and includes a connecting portion and a limiting portion. The connecting portion may be a horizontal connecting portion 233 and the limiting portion may be a vertical limiting portion 234. The horizontal connecting portion 233 is connected with the installation portion 232. The lever-type transmission member 32 passes between the vertical limiting portion 234 and the installation portion 232. The swing support surface 236 is provided on a side of the vertical limiting portion 234 near the second end of the lever-type transmission member 32.

In some exemplary embodiments, as shown in FIG. 10, there are two lever support portions 231 provided one above the other, and the vertical limiting portions 234 of the two lever support portions 231 extend towards each other. The vertical limiting portions 234 of the two lever support portions 231 each are provided with the swing support surface 236, and the upper and lower ends of the lever-type transmission member 32 are respectively in line contact with the swing support surfaces 236 of the upper and lower lever support portions 231.

In some exemplary embodiments, as shown in FIG. 10 and FIG. 15, the vertical limiting portion 234 includes an avoidance slope 235 adjacent to the installation portion 232. The avoidance slope 235 gradually inclines away from the installation portion 232 along the direction from the second end to the first end of the lever-type transmission member 32. The swing support surface 236 is formed at an edge of the avoidance slope 235 near the second end of the lever-type transmission member 32.

As shown in FIG. 10 and FIG. 15, the lever support portion 231 is located at the front side of the installation portion 232. The rear side surface (i.e., the end surface adjacent to the installation portion 232) of the vertical limiting portion 234 is the avoidance slope 235, which gradually inclines forward along the direction from right to left (i.e., from the second end to the first end of the lever-type transmission member 32) and away from the installation portion 232. The swing support surface 236 of the lever-type transmission member 32 is formed at the edge of the right end of the avoidance slope 235 (i.e., the edge near the second end of the lever-type transmission member 32), and the swing support surface 236 smoothly connects the right end surface of the vertical limiting portion 234 with the avoidance slope 235.

The arrangement of the avoidance slope 235 can prevent the vertical limiting portion 234 from influencing the swing of the lever-type transmission member 32. The swing support surface 236 is arranged on a side of the avoidance slope 235 near the second end of the lever-type transmission member 32, so as to maximize the moment arm of the first end of the lever-type transmission member 32 and decrease the pressing force when pressing the control push button 31.

In some exemplary embodiments, as shown in FIG. 4, FIG. 12 and FIG. 14, the sliding assembly includes a slide seat 21, an installation bracket 22 and an end cover 23. The slide seat 21 is slidably installed on the slide rail 1. The slide seat 21 and the installation bracket 22 are arranged side by side along a direction perpendicular to the sliding direction of the sliding assembly. For example, the slide seat 21 and the installation bracket 22 are transversely arranged side by side. The slide seat 21 and the installation bracket 22 are fixed by the end cover 23 located a side of the slide seat 21 and the installation bracket 22 away from the slide rail 1.

As shown in FIG. 10, the lever support portion 231 is provided on the end cover 23. The end cover 23 can be used as the installation portion 232, and the lever support portion 231 is provided on the end cover 23. The lever support portion 231 and the end cover 23 may be an integrated structure or may be a separate connection structure.

In some exemplary embodiments, as shown in FIG. 14, the end cover 23 includes a first side surface 237 away from the slide rail 1, and the installation bracket 22 includes a second side surface 221 adjacent to the slide seat 21. The swing support surface 236 is a cylindrical surface, and a central axis O of the cylindrical surface is an intersection line of a first plane 238 (indicated by a dashed line) and a second plane 222 (indicated by a dashed line). The first plane 238 is parallel to the first side surface 237, is at a first set distance D1 from the first side surface 237, and is located on a side of the first side surface 237 close to the slide rail 1. The second plane 222 is parallel to the second side surface 221, is at a second set distance D2 from the second side surface 221, and is located on the side of the second side surface 221 away from the slide seat 21.

As shown in FIG. 14, the slide seat 21 and the installation bracket 22 arranged side by side are located on the right side and the left side, respectively. The rear sides of the slide seat 21 and the installation bracket 22 are fixed by the end cover 23. The fixation between the end cover 23 and the slide seat 21 and between the end cover 23 and the installation bracket 22 are realized by screws 24. A front side portion of the slide seat 21 is installed in the chute 11 on the rear side of the slide rail 1.

As shown in FIG. 15, the rear side surface of the end cover 23 (i.e., the side surface away from the slide rail 1) is the first side surface 237, and the first plane 238 is a vertical surface parallel to the first side surface 237 and located in front of the first side surface 237 (i.e., a side close to the slide seat 21). The first plane 238 is at a first set distance D1 from the first side surface 237.

The right side surface of the installation bracket 22 (i.e., the side surface adjacent to the slide seat 21) is the second side surface 221, and the second plane 222 is a vertical plane parallel to the second side surface 221 and located on the left side of the second side surface 221 (i.e., a side away from the slide seat 21). The second plane 222 is at a second set distance D2 from the second side surface 221.

The first plane 238 is perpendicular to the second plane 222, and the intersection line of the first plane 238 and the second plane 222 is a vertical line, which is the central axis O of the swing support surface 236.

In order to make the appearance of the slide rail assembly aesthetic after installation, the rear side of the slide rail assembly should be arranged as close to the wall as possible, that is, the slide rail 1 and the sliding assembly should be extremely close to the wall with a small distance from the wall. The factors that affect the slide rail assembly to be close to the wall include a thickness of the end cover 23, a thickness of the lever-type transmission member 32 and a space for the movement of the friction block 35. The sum of the thickness of the end cover 23, the thickness of the lever-type transmission member 32 and the space for the movement of the friction block 35 is 1.5 mm+1.5 mm+2 mm=5 mm, or 1.2 mm+1.2 mm+1.6=4 mm, within the range of 4 mm-5 mm. The first set distance D1 can be set to be approximately equal to the sum of the thickness of the end cover 23, the thickness of the lever-type transmission member 32 and the space for the movement of the friction block 35, so the value of D1 is within the range of 4 mm-5 mm.

For aesthetic purpose, the vertical limiting portion 234 is hidden in the installation bracket 22, and the right end surface of the vertical limiting portion 234 does not protrude from the right end surface of the installation bracket 22. In order to ensure the best labor-saving effect of the lever-type transmission member 32, the right end surface of the vertical limiting portion 234 can be as close as possible to the right end surface of the installation bracket 22. Therefore, the distance between the central axis O of the swing support surface 236 (i.e., cylindrical surface, which smoothly connects the right end surface of the vertical limiting portion 234 with the avoidance slope 235) and the right end surface of the installation bracket 22 is not less than the radius of the swing support surface 236. Therefore, the second set distance D2 can be set to be not less than the radius of the swing support surface 236.

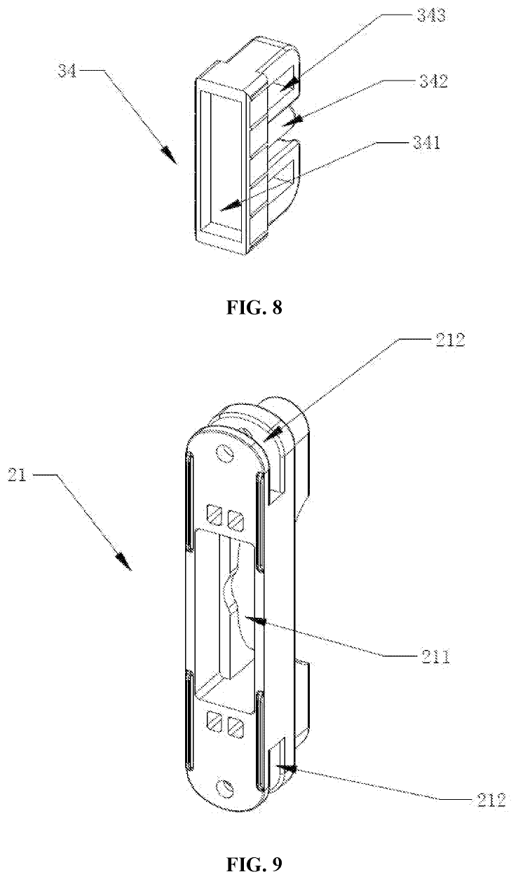

In some exemplary embodiments, as shown in FIG. 4, FIGS. 8-9, FIG. 12 and FIG. 14, the locking mechanism further includes an installation seat 34. The slide seat 21 is provided with an installation through hole 211. The installation seat 34 is installed in the installation through hole 211. One side of the installation seat 34 is provided with an installation groove 341 for installing the friction block 35. The elastic restoring member 36 is provided between the other side of the installation seat 34 and the end cover 23. The second end of the transmission member 32 is connected with the installation seat 34.

As shown in FIG. 9, FIG. 12 and FIG. 14, the slide seat 21 is provided with the installation through hole 211 penetrating from front to back, and the installation seat 34 is installed in the installation through hole 211 and can move in the front-rear direction.

As shown in FIG. 8, FIG. 12 and FIG. 14, the installation seat 34 is provided with an installation groove 341 at the front side in which the friction block 35 is fixedly installed, and the front end surface of the friction block 35 protrudes from the front end surface of the installation seat 34 so as to contact with the chute 11 of the slide rail 1. The installation seat 34 is provided with an installation post 342 at the rear side, and the elastic restoring member 36 can be a spring, which can be sleeved outside the installation post 342 and compressed between the installation seat 34 and the end cover 23.

As shown in FIG. 6 and FIG. 8, the installation seat 34 is provided with a slot 343, and the transmission member 32 is provided with a plug 322 at the second end. The plug 322 is inserted into the slot 343 to realize the connection between the transmission member 32 and the installation seat 34. There may be two slots 343, which are respectively located at the upper and lower sides of the installation seat 34. Accordingly, the transmission member 32 is provided with an upper plug 322 and a lower plug 322 at the second end, and the two plugs 322 are inserted into the two slots 343 respectively.

In some exemplary embodiments, the end cover 23 is made of stainless steel, which ensures the thinnest wall thickness while ensuring the strength. The lever support portion 231 is formed by flanging and stamping process of the stainless steel end cover 23, so that the lever support portion 231 and the end cover 23 have an integrated structure. The end cover 23 is used for fixing the slide seat 21 and the installation bracket 22, and is an important stressed component.

In some exemplary embodiments, the transmission member 32 is made of stainless steel, which ensures the thinnest wall thickness while ensuring the strength.

In some exemplary embodiments, the friction block 35 is made of rubber.

It should be understood that the materials of the end cover 23, the transmission member 32 and the friction block 35 are not limited to the materials described above, but may be other materials.

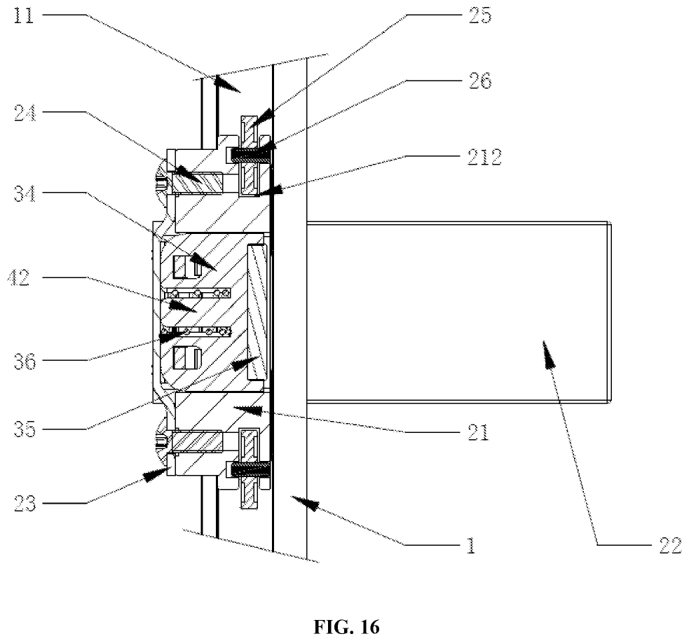

In some exemplary embodiments, as shown in FIG. 4, FIG. 16 and FIG. 17, the sliding assembly includes a slide seat 21 and a pulley 25 installed on the slide seat 21. The slide rail 1 is provided with the chute 11. The slide rail 1 may be a vertical slide rail, and the chute 11 may extend vertically. The pulley 25 is located in the chute 11 and can roll in the chute 11.

As shown in FIG. 16, the pulley 25 is installed on the slide seat 21 through a pin 26 and can freely roll around the pin 26. The arrangement of the pulley 25 can convert a sliding friction between the slide seat 21 and the chute 11 into a rolling friction between the pulley 25 and the chute 11, thereby reducing the friction force and facilitating the user to slide the slide seat 21.

In some exemplary embodiments, two pulleys 25 are provided, and they are provided at both ends of the slide seat 21 along the sliding direction of the slide seat 21. The two ends of the slide seat 21 are provided with pulley grooves 212 in which two pulleys 25 are installed. One end of the pulley groove 212 is open and both sides thereof pass through the slide seat 21, and the pulleys 25 protrude from the openings and both sides of the pulley grooves 212.

In some exemplary embodiments, as shown in FIG. 4 and FIG. 9, there are two pulleys 25 arranged up and down along the vertical sliding direction. The pulley grooves 212 for installing the two pulleys 25 are provided at the upper and lower ends of the slide seat 21, with the upper end of the upper pulley groove 212 open and both sides thereof transversely penetrating the slide seat 21, and the lower end of the lower pulley groove 212 open and both sides thereof transversely penetrating the slide seat 21.

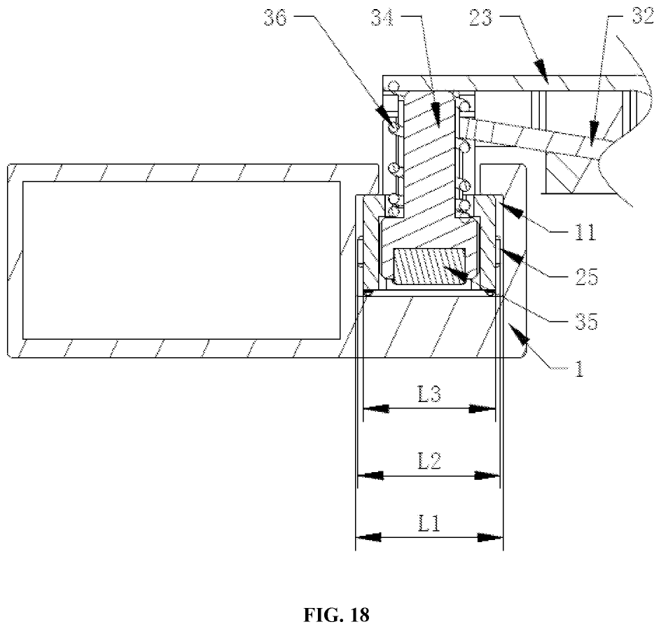

As shown in FIGS. 16-18, both lateral sides and upper end of the upper pulley 25 protrude from the upper pulley groove 212, while both lateral sides and lower end of the lower pulley 25 protrude from the lower pulley groove 212.

The width L1 of the chute 11 is larger than the diameter L2 of the pulley 25, and the diameter L2 of the pulley 25 is larger than the width L3 of the portion of the slide seat 21 extending into the chute 11.

When the control push button 31 is pressed, the installation seat 34 and the friction block 35 on the slide seat 21 move backward, so that the installation seat 34 and the friction block 35 are recessed relative to the slide seat 21 without generating friction with the chute 11. At this time, the user can grasp the sliding assembly and move it up or down.

As shown in FIG. 17, the width L1 of the chute 11 is larger than the diameter of the pulley 25, and the diameter L2 of the pulley 25 is larger than the width L3 of the portion of the slide seat 21 extending into the chute 11, both lateral sides (left and right sides) and upper end of the upper pulley 25 protrude from the upper pulley groove 212, while both lateral sides (left and right sides) and lower end of the lower pulley 25 protrude from the lower pulley groove 212, that is, the upper and lower edges of the portion of the slide seat 21 located in the chute 11 do not protrude from the contour range of the pulleys 25.

As shown in FIG. 17, when the sliding assembly slides upwards, an upward force F1 is exerted on the installation bracket 22 of the sliding assembly, and the pulleys 25 on the slide seat 21 incline under the force. Only site S1 of the upper pulley 25 and site S3 of the lower pulley 25 contact with the chute 11, which are the main stress points, while site S2 of the upper pulley 25 and site S4 of the lower pulley 25 do not serve as friction contact points. When the whole sliding assembly moves up, the friction force between the sliding assembly and the chute 11 is the rolling friction force between the pulleys 25 and the chute 11. At this time, the friction force is smaller, so that the sliding assembly slides up smoothly without jamming.

Similarly, when the sliding assembly slides downward under the action of downward force F2, only site S2 of the upper pulley 25 and site S4 of the lower pulley 25 are in contact with the chute 11, and the rolling friction force between the pulleys 25 and the chute 11 is smaller, so that the sliding assembly slides down smoothly without jamming.

As shown in FIG. 2 and FIG. 3, an embodiment of the present disclosure also provides a shower assembly, including a shower 5 and the slide rail assembly described above. The shower 5 is installed on the sliding assembly of the slide rail assembly, so that the position of the shower 5 can be adjusted by sliding the sliding assembly.

The sliding assembly includes an installation bracket 22 on which the shower 5 can be installed.

As shown in FIG. 4, a shower holder 4 can be installed on the installation bracket 22, and the shower 5 can be snap-connected to the shower holder 4. The shower 5 can rotate relative to the shower holder 4, so as to adjust the angle of the shower 5 and facilitate the use.

Embodiments of the present disclosure provide a slide rail assembly and a shower assembly, and with the slide rail assembly, it is convenient to adjust and fix the position of the shower 5, so that users can use the shower 5 conveniently.

With the slide rail assembly provided by an embodiment of the disclosure, the shower 5 can be installed on the sliding assembly, and the sliding assembly can slide along the slide rail 1, so that the shower 5 can be adjusted to a proper position and is convenient for users to use. The locking mechanism has a releasing state and a locking state, and can be used for locking or releasing the sliding assembly. When the position of the shower 5 needs to be adjusted, the locking mechanism is in the releasing state by operating the control button, and the friction block 35 of the locking mechanism is out of contact with the slide rail 1, so that the sliding assembly can slide along the slide rail 1 to adjust the position of the shower 5. After the shower 5 moves to a proper position, the control button is released, and the locking mechanism returns to the locking state under the action of the elastic restoring member 36. At this time, the friction block 35 contacts with the slide rail 1, and the sliding assembly is locked on the slide rail 1 and can not slide under the action of a friction force between the friction block 35 and the slide rail 1, so that the shower 5 can be fixed.

Therefore, with the slide rail assembly, it is convenient to adjust and fix the position of the shower 5.

Although the embodiments disclosed in the present disclosure are described above, the content described is only the embodiments adopted for facilitating the understanding of the present disclosure, and is not intended to limit the present disclosure. Without departing from the spirit and scope disclosed in the present disclosure, any person skilled in the art to which the present disclosure pertains can make any modifications and changes in the forms and details of implementation. However, the scope of patent protection of the present disclosure shall still be determined by the scope defined in the appended claims.

What is claimed is:

1. A slide rail assembly, comprising a slide rail, a sliding assembly slidably installed on the slide rail, and a locking mechanism capable of locking and releasing the sliding assembly;
wherein the locking mechanism comprises a control button, a transmission member, a friction block and an elastic restoring member, the control button is installed on the sliding assembly and comprises a movable member which is capable of reciprocating, the movable member is in transmission connection with a first end of the transmission member, one of the movable member and the transmission member is provided with a transmission surface inclined relative to a sliding direction of the sliding assembly, and the other of the movable member and the transmission member is provided with a transmission matching surface abutting against the transmission surface, a second end of the transmission member is connected with the friction block, the elastic restoring member is provided between the sliding assembly and the transmission member, and the friction block is movably installed on the sliding assembly and is capable of moving towards or away from the slide rail;
the friction block is capable of moving to contact with the slide rail under the action of the elastic restoring member, so that the sliding assembly is locked relative to the slide rail under the action of a friction force of the friction block; and the friction block is capable of moving out of contact with the slide rail under the driving of the movable member and the transmission member, so that the sliding assembly is capable of sliding relative to the slide rail.

2. The slide rail assembly according to claim 1, wherein the control button is a pressable control push button, the transmission surface is provided on the movable member, and along a pressing direction of the control push button, the transmission surface is a flat surface or an arc surface inclined in a direction away from the transmission matching surface; or
the control button is a pressable control push button, the transmission surface is provided on the transmission member, and along a pressing direction of the control push button, the transmission surface is a flat surface or an arc surface inclined towards a direction close to the transmission matching surface.

3. The slide rail assembly according to claim 1, wherein the transmission matching surface is an arc-shaped surface protruding toward the transmission surface.

4. The slide rail assembly according to claim 1, wherein the movable member is provided with a groove, the first end of the transmission member extends into the groove, and one of inner wall surfaces of the groove forms the transmission surface;
the transmission matching surface is provided on an outer surface of the transmission member; or the locking mechanism further comprises a bushing sleeved outside the first end of the transmission member, and the transmission matching surface is provided on an outer surface of the bushing.

5. The slide rail assembly according to claim 1, wherein the transmission member is a lever-type transmission member, the sliding assembly comprises an installation portion and a lever support portion fixed on the installation portion, and a portion of the lever-type transmission member close to the second end is supported on the lever support portion.

6. The slide rail assembly according to claim 2, wherein the transmission member is a lever-type transmission member, the sliding assembly comprises an installation portion and a lever support portion fixed on the installation portion, and a portion of the lever-type transmission member close to the second end is supported on the lever support portion.

7. The slide rail assembly according to claim 3, wherein the transmission member is a lever-type transmission member, the sliding assembly comprises an installation portion and a lever support portion fixed on the installation portion, and a portion of the lever-type transmission member close to the second end is supported on the lever support portion.

8. The slide rail assembly according to claim 4, wherein the transmission member is a lever-type transmission member, the sliding assembly comprises an installation portion and a lever support portion fixed on the installation portion, and a portion of the lever-type transmission member close to the second end is supported on the lever support portion.

9. The slide rail assembly according to claim 5, wherein the lever support portion comprises a swing support surface which is a cylindrical surface extending along the sliding direction of the sliding assembly, and the swing support surface is in line contact with the lever-type transmission member.

10. The slide rail assembly according to claim 6, wherein the lever support portion comprises a swing support surface which is a cylindrical surface extending along the sliding direction of the sliding assembly, and the swing support surface is in line contact with the lever-type transmission member.

11. The slide rail assembly according to claim 9, wherein the lever support portion is L-shaped, and comprises a connecting portion and a limiting portion, the connecting portion is connected with the installation portion, the lever-type transmission member passes through between the limiting portion and the installation portion, and the swing support surface is provided on a side of the limiting portion close to the second end of the lever-type transmission member.

12. The slide rail assembly according to claim 11, wherein the limiting portion comprises an avoidance slope adjacent to the installation portion, and the avoidance slope gradually inclines away from the installation portion along a direction from the second end to the first end of the lever-type transmission member, and the swing support surface is formed at an edge of the avoidance slope near the second end of the lever-type transmission member.

13. The slide rail assembly according to claim 12, wherein the sliding assembly comprises a slide seat, an installation bracket and an end cover, the slide seat is slidably installed on the slide rail, the slide seat and the installation bracket are provided side by side along a direction perpendicular to the sliding direction of the sliding assembly and fixed by the end cover, and the end cover is located on a side of the slide seat and the installation bracket away from the slide rail;
the end cover comprises a first side surface away from the slide rail, and the installation bracket comprises a second side surface adjacent to the slide seat;
the lever support portion is provided on the end cover, the swing support surface is a cylindrical surface, a central axis of the cylindrical surface is an intersection line of a first plane and a second plane, the first plane is parallel to the first side surface, is at a first set distance from the first side surface, and is located on a side of the first side surface close to the slide rail, and the second plane is parallel to the second side surface, is at a second set distance from the second side surface, and is located on a side of the second side surface away from the slide seat.

14. The slide rail assembly according to claim 13, wherein the locking mechanism further comprises an installation seat, the slide seat is provided with an installation through hole, the installation seat is installed in the installation through hole, the installation seat is provided with an installation groove for installing the friction block at one side, the elastic restoring member is provided between the other side of the installation seat and the end cover, and the second end of the transmission member is connected with the installation seat.

15. The slide rail assembly according to claim 1, wherein the sliding assembly comprises a slide seat and a pulley, the pulley is installed on the slide seat, a chute is provided on the slide rail, and the pulley is located in the chute and is capable of rolling in the chute.

16. The slide rail assembly according to claim 2, wherein the sliding assembly comprises a slide seat and a pulley, the pulley is installed on the slide seat, a chute is provided on the slide rail, and the pulley is located in the chute and is capable of rolling in the chute.

17. The slide rail assembly according to claim 3, wherein the sliding assembly comprises a slide seat and a pulley, the pulley is installed on the slide seat, a chute is provided on the slide rail, and the pulley is located in the chute and is capable of rolling in the chute.

18. The slide rail assembly according to claim 4, wherein the sliding assembly comprises a slide seat and a pulley, the pulley is installed on the slide seat, a chute is provided on the slide rail, and the pulley is located in the chute and is capable of rolling in the chute.

19. The slide rail assembly according to claim 15, wherein there are two pulleys, which are provided at both ends of the slide seat along a sliding direction of the slide seat, pulley grooves for installing the two pulleys are provided at both ends of the slide seat, one end of each of the pulley grooves is open, and both sides of each of the pulley grooves penetrate through the slide seat, the pulleys protrude from the openings and both sides of the pulley grooves;
a width of the chute is larger than a diameter of each of the pulleys, and the diameter of each of the pulleys is larger than a width of a portion of the slide seat extending into the chute.

20. A shower assembly, comprising a shower and the slide rail assembly according to claim 1, wherein the shower is installed on the sliding assembly of the slide rail assembly.
